(19) United States
(12) Patent Application Publication
(10) Pub. No.: US 2012/0048393 A1
(43) Pub. Date: Mar. 1, 2012

(54) DETACHABLE IMPACT SPRINKLER HEAD REPAIR CLIP

(76) Inventor: Kevin Waters, Farmington, UT (US)

(21) Appl. No.: 12/868,727

(22) Filed: Aug. 26, 2010

(51) Int. Cl. F16K 43/00

(52) U.S. Cl. 137/315.01

(57) ABSTRACT

A detachable impact sprinkler head repair clip is disclosed for repairing broken attachment clips of closed-case impact sprinkler heads. The detachable impact sprinkler head repair clip includes a base plate defining a lateral plane, from which four legs descend to distal ends comprising cammed latching clips, and from which a plurality of engaging components ascend around a longitudinal axis to distal ends which detachably engage the cover plate of closed-case impact sprinkler head.

### BACKGROUND OF THE INVENTION

1. Field of the Invention

This invention relates to irrigation sprinklers, and more particularly relates to improved attachment clips on pop-up, rotating impact sprinklers.

2. Description of the Related Art

The present invention teaches an improvement to closed-case impact sprinkler heads. Rotating impact sprinkler heads comprise tubular bodies and are well-known in the art. Rotating impact sprinklers were first taught in Englehardt in 1935 (U.S. Pat. No. 1,997,901), and have been manufactured under a variety of trade names since the 1930s, including Rain Bird®, Orbit®, and others.

Traditional rotating impact sprinklers necessarily sit above ground level and irrigate a roughly predetermined area of ground with pressurized jets of water. Traditional impact sprinklers obstruct lawnmowers, vehicles, and other devices moving across the irrigated ground.

Improvements in the art since 1935 include closed-case impact sprinkler heads, which sprinklers comprise an outer case with an internally positioned riser sleeve that upwardly extends a pop-up impact sprinkler head when water pressure in applied to the closed-case impact sprinkler.

Closed-case impact sprinkler heads descend into their outer cases when water pressure is reduced, and descend out of the path of lawn mowers, vehicles and other devices traversing the ground the sprinkler is used to irrigate. To prevent dirt, vegetation, gravel and aggregates from clogging the closed-case impact sprinkler head, traditional closed-case sprinkler heads comprise cover plates (also called closure caps or lids in prior art) which are affixed to each closed-case impact sprinkler head. The cover plates are affixed at their center to the impact sprinkler head with attachment clips permanently conjoined to the top of the sprinkler head.

Cover plates are meant only to protect closed-case impact sprinklers from clogging, and minimal amounts of traffic. They are not designed to support the weight of lawnmowers, vehicles, people, animals or other items that come in contact with the cover plate when traversing the ground. Because cover plates lack sufficient lateral and leveraged support, and neither the cover plates or the attachment clips are engineered to support large amounts of weight, the attachment clips break under the weight of items moving across them.

There exists no means in the art of repairing or reattaching cover plates to damaged closed-case impact sprinkler heads. Gardeners, homeowners, grounds keepers, and others charged with sprinkler head maintenance are forced to purchase and reinstall new closed-case impact sprinklers when attachment clips break because there exists no convenient means of replacing or repairing the attachment clips.

### SUMMARY OF THE INVENTION

From the foregoing discussion, it should be apparent that a need exists for repairing the attachment clips on closed-case sprinkler heads. Beneficially, such an attachment clip would overcome many of the difficulties with prior art by providing a means for repairing the attachment clips. and reattaching the closure plate.

The present invention has been developed in response to the present state of the art, and in particular, in response to the problems and needs in the art that have not yet been fully solved by currently available devices. Accordingly, the present invention has been developed to provide a detachable impact sprinkler head repair clip for reattaching the cover plate to a closed-case impact sprinkler head. The detachable impact sprinkler head repair clip comprises a base plate having a planar topside, a planar underside, and one or more outside lateral edge(s), with a lateral axis extending outward from the center of the topside to one of the one or more lateral edge(s), and with a longitudinal axis extending orthogonally from the topside plane and upwardly from the base plate.

The detachable impact sprinkler head repair clip further comprises two or more male engaging components conjoined at proximal ends to the topside, radially disposed around the longitudinal axis to another, rising along the longitudinal axis to distal ends, the distal ends insertably and releasably connectable to the cover plate of a closed-case impact sprinkler head, the engaging components defining a semi-annular recess between them, the distal ends of the engaging components comprising one or more of a cammed outer surface, a rounded end, and a latching clip.

The detachable impact sprinkler head repair clip comprising four legs affixed at proximal ends to the underside of the base plate, extending orthogonally downwardly from the underside to distal ends, the distal ends comprising one or more of a cammed inner surface and a latching clip, the legs collectively forming a receptacle releasably attachable to the sprinkler head of a closed-case impact sprinkler head.

In some embodiments, the detachable impact sprinkler head repair clip is polygonal across its two widest axes. In other embodiments, the detachable impact sprinkler head repair clip is hexagonal across its two widest axes.

The one or more engaging members may be semi-cylindrical in shape. In still further embodiments, the detachable impact sprinkler head repair clip may comprise one or more engaging members which are semi-conical in shape.

The one or more engaging components and legs may be manufactured from a rigid, durable polymer material in alternative embodiments.

Alternatively, the detachable impact sprinkler head repair clip may be manufactured as single piece using a 3D printing process, or may be manufactured from a metal using a direct metal laser sintering (DMLS) process.

In some embodiments, the underside defines an annular recess for receiving remnants of original broken attachment clips affixed to the impact sprinkler head, and in some embodiments the base plate comprises an arrow indicating the proper orientation of the detachable impact sprinkler head repair clip relative to the sprinkler head nozzle.

The detachable impact sprinkler head repair clip may also comprise a hole extending from the underside upward along the longitudinal axis into the base plate, the hole having a diameter sufficient to house a portion of a pivot pin extending above the sprinkler head.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1A is an upper isometric perspective view of a detachable impact sprinkler head clip in accordance with the present invention;

FIG. 1B is a lower isometric perspective view of a detachable impact sprinkler head clip in accordance with the present invention;

FIG. 2A is a side perspective view of a detachable impact sprinkler head clip in accordance with the present invention (shown attached to an unclaimed sprinkler head environmentally depicted);

FIG. 2B is a top perspective view of a detachable impact sprinkler head clip in accordance with the present invention (shown attached above an unclaimed sprinkler head environmentally depicted); and

FIG. 2C is a side perspective view of a detachable impact sprinkler head clip in accordance with the present invention (shown with an unclaimed sprinkler head and an unclaimed closure cap environmentally depicted).

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

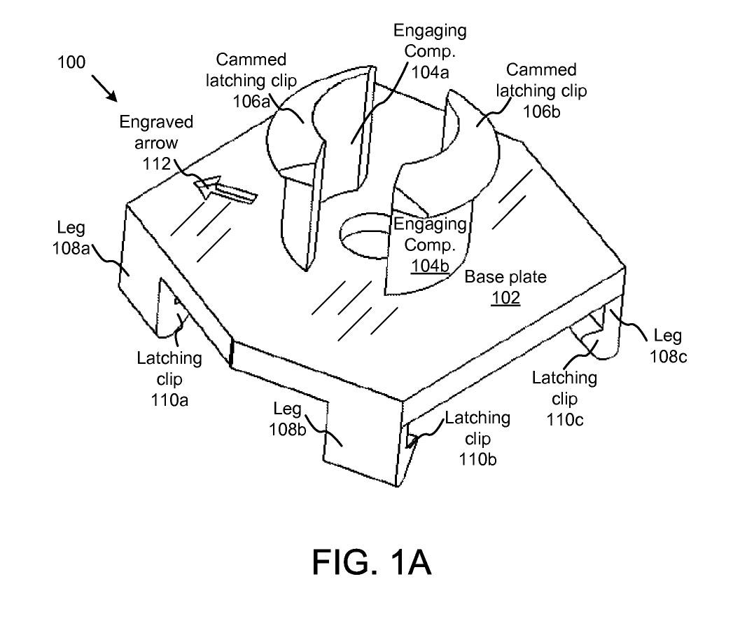

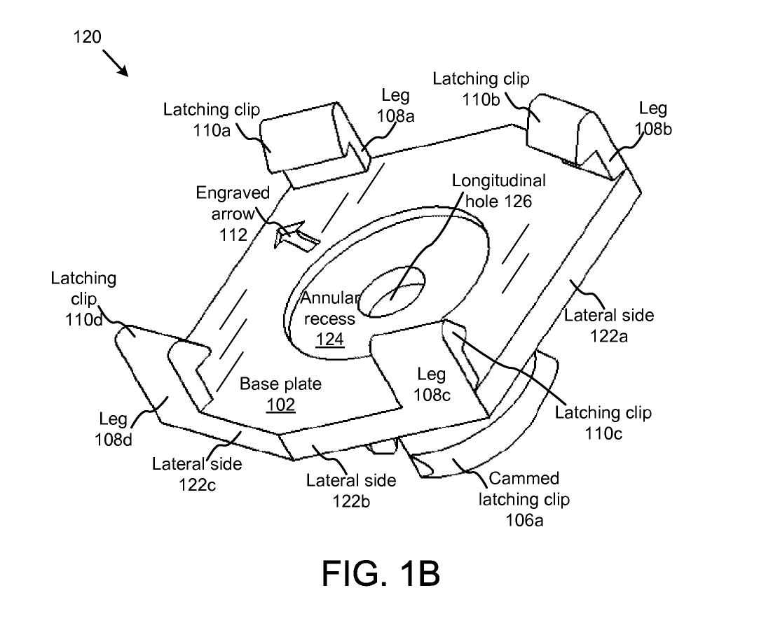

FIG. 1A is an upper isometric perspective view of a detachable impact sprinkler head repair clip 100 in accordance with the present invention. The detachable impact sprinkler head clip 100 comprises a base plate 102, an engaging component 104a, an engaging component 104b, a cammed latching clip 106a, a cammed latching clip 106b, a leg 108a, a leg 108b, a leg 108c, a latching clip 110a, a latching clip 110b, a latching clip 110c, and an engraved arrow 112.

The base plate 102 comprises a relatively rigid polygonal plate. In the shown embodiments, the base plate 102 is hexagonal. In other embodiments the base plate 102 is square, circular, triangular, or the like. The base plate 102 may be manufactured from a polymer material using a 3D printing process, or a direct metal laser sintering (DMLS) process from metals, or using means well-known to those of skill in the art.

The base plate 102 comprises a flat, or planar, topsurface or topside. The lateral plane of the base plate extends across topside of the base plate 102. The lateral axis of the present invention extends outward from the center of the topside to one of the one or more lateral edge(s) (further described below in relation to FIG. 1B).

A longitudinal axis extends orthogonally from the topside plane and upwardly from the base plate 102.

The detachable impact sprinkler head repair clip 100 further comprises one or more male engaging component(s) 104a-b conjoined at proximal end(s) to the topside, which are radially disposed around the longitudinal axis to another, meaning they arranged in a circular fashion around the center of the topside of the base plate 102. Alternatively, the engaging components 104a-b may be arranged in accordance with other patterns or irregularly.

The engaging components 104a-b rise along the longitudinal axis to distal ends. The distal ends of the engaging components 104a-b are insertably and releasably connectable to the cover plate of a closed-case impact sprinkler head. The engaging components releasably attach to the cover plate by being inserted into its center hole and latching in place.

The engaging components 104a-b, in the shown embodiment, are semi-cylindrical in shape, meaning they are shaped like one side of a cylinder cut down its longitudinal axis into one or more equal slices. Alternatively, the components 104a-b may be conical in shape. In some embodiments, the engaging components 104a-b define a semi-annular recess between them.

The distal ends of the engaging components 104a-b may be rounded. The distal ends of the engaging components 104a-b may comprise one or more of a cammed outer surface, meaning that top edge of the distal end may slant down toward the extending lateral axis.

The top edge of distal ends may be rounded in shape as shown. The distal ends of the engaging components 10a-b may comprise one or more cammed latching clips 106a-b disposed on the outer edge of the engaging components 104a-b, as measured on the lateral axis.

The latching clips 106a-b are well-known to those of skill in the art, and comprise eave-like ledges that jut beyond the side of the distal ends of the engaging components 104a-b as shown.

The base plate 102 further comprises a flat, or planar, under surface or underside, which is approximately parallel to the topside, or parallel thereto to within thirty (30) degrees.

A plurality of legs 108 are disposed below the underside of the base plate 102. In the preferred embodiment, four legs are disposed beneath the underside, three of which, 108a-c, are shown in FIG. 1A. The legs 108a-c are affixed at proximal ends to the underside of the base plate 102. The legs 108a-c extend in an orthogonal direction downwardly from the underside to distal ends. The distal ends of the legs 108a-c comprise one or more of a cammed inner surface in some embodiments. In other embodiments, the distal ends of the legs 108a-c comprise latching clips on their inside surfaces. The legs 108, acting collectively, form a receptacle which can be releasably attached to the sprinkler head of a closed-case impact sprinkler head. The legs 108a-c grip the sprinkler head and secure the cover plate to the sprinkler head.

The legs 108a-c may be disposed directly below the polygonal vertices of the base plate 102.

The latching clips 110a-c are well-known to those of skill in the art, and comprise eave-like ledges that jut beyond the side of the distal ends of the legs 108a-c as shown.

The engraved arrow 112 comprises an arrow-shaped engraving, or arrow-like recess in the base plate 102. In some embodiments of the present invention, the engraved arrow 112 may be embossed, sintered, or otherwise raised above the surface of the base plate 102 rather than engraved or recessed therein.

FIG. 1B is a lower isometric perspective view of a detachable impact sprinkler head repair clip 120 in accordance with the present invention. The detachable impact sprinkler head clip 120 comprises a base plate 102, a cammed latching clip 106a, a leg 108a, a leg 108b, a leg 108c, a leg 108d, a latching clip 110a, a latching clip 110b, a latching clip 110c, a latching clip 110d, an engraved arrow 112, a lateral side 122a, a lateral side 122b, a lateral side 122c, an annular recess 124, and a longitudinal hole 126.

The base plate 102, cammed latching clip 106a, legs 108a-d, latching clips 110a-d, and engraved arrow 112 are all substantially described above in relation to FIG. 1A.

The lateral sides 122a-c comprise the straight longitudinally rising edges of the base plate 102. In various embodiments, the lateral sides 122a-c may vary in height from 0.1 millimeters to twenty centimeters. The lateral sides 122a-c lie on the outside lateral edge(s) of the base plate 102 and define the polygonal shape of the base plate 102 across its lateral plane.

The detachable impact sprinkler head repair clip 120 further comprises an annular recess 124. In the shown embodiment, the underside in recessed through its center for receiving broken remnants of the original attachment clips affixed to the sprinkler head, which original attachment clips were used to attach the sprinkler head to the cover plate. The depth of the annual recess 124 may vary from anywhere across a range from zero millimeters to anything depth less than the height of the base plate 102 on it longitudinal axis. The annular recess 124, in some embodiments, may be ovoid, rectangular, polygonal, or irregularly shaped.

In the preferred embodiment, the detachable impact sprinkler head repair clip 120 comprises a longitudinal hole 126 running through the height of the base plate 102. This longitudinal hole 126 is of a diameter large enough to receive and enclose the pivot pin of the sprinkler head. In some embodiments, the longitudinal hole 126 does not rise completely through the height of the base plate 102. Rather, the longitudinal hole 126 rises from the underside toward the topside only to a distance that is high enough to house the pivot pin.

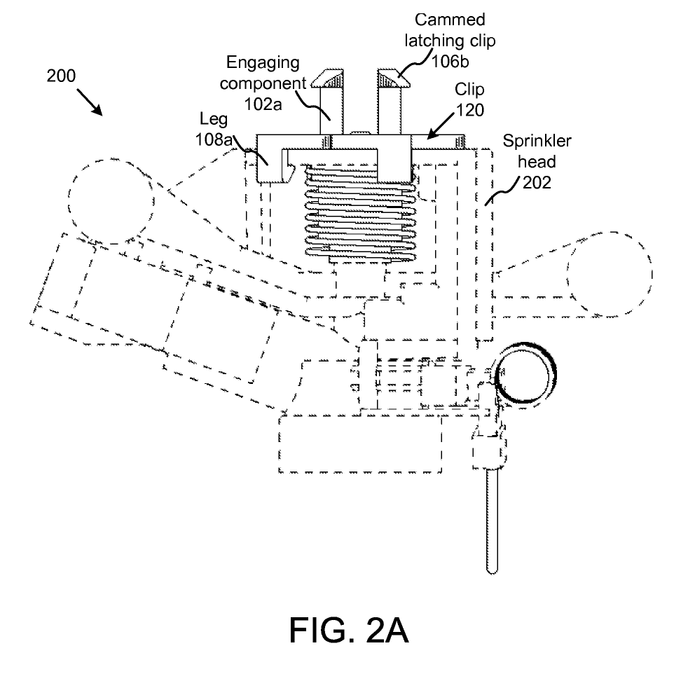

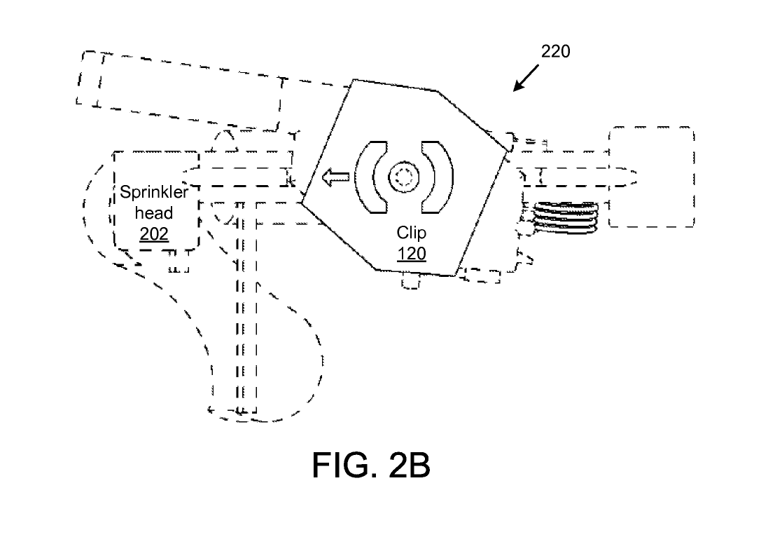

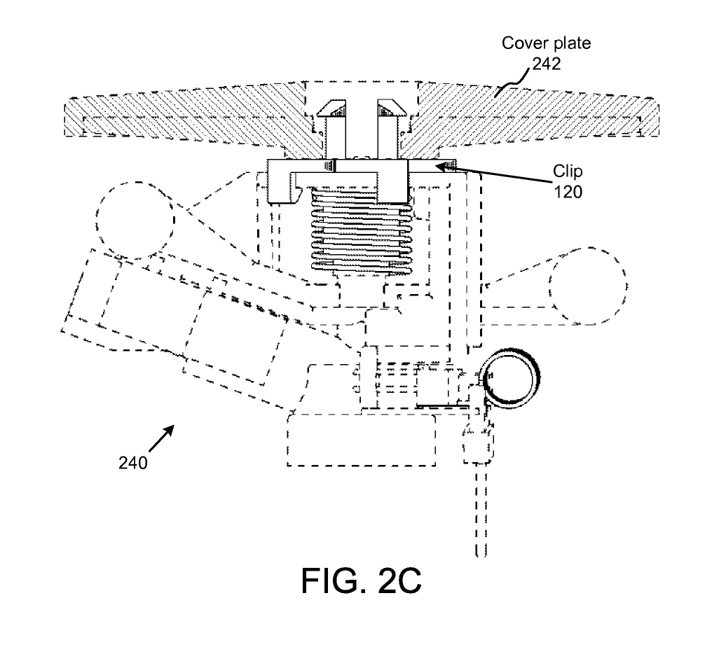

FIG. 2A is a side perspective view of a detachable impact sprinkler head repair clip 200 in accordance with the present invention (shown attached to an unclaimed sprinkler head environmentally depicted). The detachable impact sprinkler head repair clip 200 comprises a clip 120 comprising a cammed latching clip 106b, leg 108a and an engaging component 102a. A sprinkler head 202 is shown attached to the clip 120.

The clip 120, engaging component 102a, latching clip 106b, leg 108a, and sprinkler head 202 are substantially described above in relation to FIGS. 1A-1B.

The shown embodiment depicts the present invention from a side perspective.

FIG. 2B is a top perspective view of a detachable impact sprinkler head repair clip 220 in accordance with the present invention (shown attached above an unclaimed sprinkler head environmentally depicted). The detachable impact sprinkler head repair clip 220 releasably attached to a sprinkler head 202.

The clip 120 and sprinkler head 202 are substantially described above in relation to FIGS. 1A-2A.

FIG. 2C is a side perspective view of a detachable impact sprinkler head clip 240 in accordance with the present invention (shown with an unclaimed sprinkler head and an unclaimed sectioned closure cap environmentally depicted). The detachable impact sprinkler head repair clip 240 comprises a clip 120. A sprinkler head 202 is shown attached to the clip 120. The detachable impact sprinkler head repair clip 240 comprises a clip 120 comprising a clip 120 releasably attached to a cover plate 242.

The clip 120 and cover plate 242 are substantially described above in relation to FIGS. 1A-2B.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A detachable impact sprinkler head repair clip for reattaching a cover plate to a closed-case impact sprinkler head with broken original attachment clips, the detachable impact sprinkler head repair clip comprising:
a base plate having a planar topside, a planar underside, and one or more outside lateral edge(s), with a lateral axis extending outward from the center of the topside to one of the one or more lateral edge(s), and with a longitudinal axis extending orthogonally from the topside plane and upwardly from the base plate;
two or more male engaging components conjoined at proximal ends to the topside, radially disposed around the longitudinal axis to another, rising along the longitudinal axis to distal ends, the distal ends insertably and releasably connectable to the cover plate of a closed-case impact sprinkler head, the engaging components defining a semi-annular recess between them, the distal ends of the engaging components comprising one or more of a cammed outer surface, a rounded end, and a latching clip;
four legs affixed at proximal ends to the underside of the base plate, extending orthogonally downwardly from the underside to distal ends, the distal ends comprising one or more of a cammed inner surface and a latching clip, the legs collectively forming a receptacle releasably attachable to the sprinkler head of a closed-case impact sprinkler head.

2. The detachable impact sprinkler head repair clip of claim 1, wherein the base plate is polygonal across its two widest axes.

3. The detachable impact sprinkler head repair clip of claim 2, wherein the base plate is hexagonal across its two widest axes.

4. The detachable impact sprinkler head repair clip of claim 1, wherein the one or more engaging members are semi-cylindrical in shape.

5. The detachable impact sprinkler head repair clip of claim 1, wherein the one or more engaging members are semi-conical in shape.

6. The detachable impact sprinkler head repair clip of claim 1, wherein the one or more engaging components and legs are manufactured from a rigid, durable polymer material.

7. The detachable impact sprinkler head repair clip of claim 1, wherein the detachable impact sprinkler head clip is manufactured as single piece using a 3D printing process. (the 3D process was just for prototyping, it will probably be injection molded when manufactured)

8. The detachable impact sprinkler head repair clip of claim 1, wherein the underside defines an annular recess for receiving remnants of original broken attachment clips affixed to the impact sprinkler head nozzle.

9. The detachable impact sprinkler head repair clip of claim 1, wherein the base plate comprises an arrow indicating the proper orientation of the detachable impact sprinkler head repair clip relative to the sprinkler head.

10. The detachable impact sprinkler head repair clip of claim 1, further comprising a hole extending from the underside upward along the longitudinal axis into the base plate, the hole having a diameter sufficient to house a portion of a pivot pin extending above the sprinkler head.

11. The detachable impact sprinkler head repair clip of claim 1, wherein the detachable impact sprinkler head is manufactured from a metal using a direct metal laser sintering (DMLS) process.
